(19) United States
(12) Patent Application Publication
(10) Pub. No.: US 2014/0000442 A1
(43) Pub. Date: Jan. 2, 2014

(54) INFORMATION PROCESSING APPARATUS, INFORMATION PROCESSING METHOD, AND PROGRAM

(71) Applicant: SONY CORPORATION, Tokyo (JP)

(72) Inventor: Yasushi MIYAJIMA, Kanagawa (JP)

(73) Assignee: SONY CORPORATION, Tokyo (JP)

(21) Appl. No.: 13/894,552

(22) Filed: May 15, 2013

(30) Foreign Application Priority Data
Jun. 29, 2012 (JP) 2012-146545

(51) Int. Cl. G10H 1/00

(52) U.S. Cl. CPC G10H 1/0008
USPC 84/609

(57) ABSTRACT

Provided is an information processing apparatus, including a searching unit that searches each of a plurality of sections included in an original musical piece for a next section that is temporally adjacent in the original musical piece and an alternative section having a same attribute as the next section, and generates a plurality of section sequences, and a selecting unit that selects at least one section sequence from the plurality of section sequences.

### BACKGROUND

The present disclosure relates to an information processing apparatus, an information processing method, and a program.

In the past, for example, in a musical piece delivery service, in order to help a user determine whether or not to purchase a musical piece, a shortened version for trial listening is provided to the user separately from a final version to be sold. Generally, a part of a musical piece is clipped to generate a shortened version. As the shortened version is replayed, the user can become aware of content of the musical piece in a short time and determine whether or not the musical piece meets the user's preference.

A shortened version of a musical piece is also necessary when a movie (including a slide show) is produced. When a movie with background music (BGM) is produced, generally, a part of a desired musical piece is clipped according to a time necessary to replay an image sequence. Then, the clipped part is added to a movie as BGM.

There are cases in which the user who has already obtained the whole musical piece and desires to be aware of content of the musical piece in a short time manually performs a digest replay by repeating fast-forwarding and replay operations. Further, there are cases in which a double-speed replay is performed. However, in the former case, depending on the user, it is difficult to accurately perform a digest replay without failing to listen to a characteristic part of a musical piece. Further, it is bothersome to intermittently repeat the fast-forwarding and replay operations. In addition, beat intervals collapse, and thus musicality of a musical piece is likely to deteriorate. In the latter case, a sound different from an original musical piece is replayed as a musical piece.

As an example of a technique of automatically shortening a replay time of a musical piece, there is a technique disclosed in JP 2012-088632A. In the technique disclosed in JP 2012-088632A, characteristic bars are extracted from a musical piece and then connected, so that a replay time of a musical piece is reduced.

### SUMMARY

However, in the technique of the related art, a musical progression of a musical piece including coherent developmental content is not easily reproduced in a shortened version. For example, in a technique of clipping a part having a predetermined time length from the beginning of a musical piece, a main feature of a musical piece is unlikely to be included in a shortened version. In a technique of clipping a part including a chorus from the middle of a musical piece, a main feature of a musical piece starts abruptly. Further, in any case, a replay is likely to end while something is in progress.

In the technique disclosed in JP 2012-088632A, since bars that are separate in an original musical piece are connected, relatively many discontinuous points are included in a shortened version of a musical piece. For this reason, when a shortened version is replayed, lyrics or instrumental sounds are inevitably cut off at discontinuous points, and the atmosphere of a musical piece suddenly changes. As a result, there are cases in which the user is given an unnatural impression or an uncomfortable feeding.

In this regard, it is desirable to provide a system capable of generating a shortened version of a musical piece without causing factitiousness arising from discontinuous points while maintaining a musical progression of a musical piece as much as possible.

According to an embodiment of the present disclosure, there is provided an information processing apparatus, including a searching unit that searches each of a plurality of sections included in an original musical piece for a next section that is temporally adjacent in the original musical piece and an alternative section having a same attribute as the next section, and generates a plurality of section sequences, and a selecting unit that selects at least one section sequence from the plurality of section sequences.

According to an embodiment of the present disclosure, there is provided an information processing method executed by a control unit of an information processing apparatus, the information processing method including searching each of a plurality of sections included in an original musical piece for a next section that is temporally adjacent in the original musical piece and an alternative section having a same attribute as the next section, and generating a plurality of section sequences, and selecting at least one section sequence from the plurality of section sequences.

According to an embodiment of the present disclosure, there is provided 20. a program for causing a computer controlling an information processing apparatus to function as a searching unit that searches each of a plurality of sections included in an original musical piece for a next section that is temporally adjacent in the original musical piece and an alternative section having a same attribute as the next section, and generates a plurality of section sequences, and a selecting unit that selects at least one section sequence from the plurality of section sequences.

According to the embodiments of the present disclosure described above, it is possible to generate a shortened version of a musical piece without causing factitiousness arising from discontinuous points while maintaining a musical progression of a musical piece as much as possible.

### BRIEF DESCRIPTION OF THE DRAWINGS

FIG. 1 is a block diagram illustrating an example of a configuration of an information processing apparatus according to an embodiment;

FIG. 2 is an explanatory diagram for describing an example of a structure of attribute data;

FIG. 3 is an explanatory diagram for describing an example of a section sequence of an original musical piece;

FIG. 4 is an explanatory diagram for describing a next section and an alternative section;

FIG. 5 is an explanatory diagram for describing an example of a search rule;

FIG. 6 is an explanatory diagram for describing an example of a section sequence candidate generated based on the section sequence of the original musical piece illustrated in FIG. 3;

FIG. 7 is an explanatory diagram for describing suspension of tracking in a searching process;

FIG. 8 is an explanatory diagram for describing an example of an evaluation parameter value of each section sequence candidate illustrated in FIG. 6;

FIG. 9 is an explanatory diagram for describing an example of a graphical user interface (GUI) causing a user to designate a section sequence;

FIG. 10 is an explanatory diagram for describing an example of a reconstruction process according to an embodiment;

FIG. 11 is an explanatory diagram for describing another example of a search rule;

FIG. 12 is an explanatory diagram for describing an example of a section sequence for an extension version;

FIG. 13 is a flowchart illustrating an example of a general flow of a process according to an embodiment;

FIG. 14 is a flowchart illustrating an example of a detailed flow of the searching process illustrated in FIG. 13;

FIG. 15 is a block diagram illustrating an example of a configuration of an information processing apparatus according to a first modified example;

FIG. 16A is an explanatory diagram for describing a first example of a time length calculation process by a setting unit illustrated in FIG. 15;

FIG. 16B is an explanatory diagram for describing a second example of a time length calculation process by the setting unit illustrated in FIG. 15;

FIG. 17 is a block diagram illustrating an example of a configuration of a server device according to a second modified example; and

FIG. 18 is a block diagram illustrating an example of a configuration of a terminal device according to the second modified example.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will proceed in the following order.

1. Configuration example of information processing apparatus according to embodiment

2. Example of flow of process according to embodiment

3. First modified example

4. Second modified example

5. Conclusion

### 1. Configuration Example of Information Processing Apparatus According to Embodiment

An information processing apparatus that will be described in this section may be a terminal device such as a personal computer (PC), a smart phone, a personal digital assistant (PDA), a music player, a game terminal, or a digital household electrical appliance. Further, the information processing apparatus may be a server device that executes processing which will be described later according to a request transmitted from the terminal device. The devices may be physically implemented using a single computer or a combination of a plurality of computers.

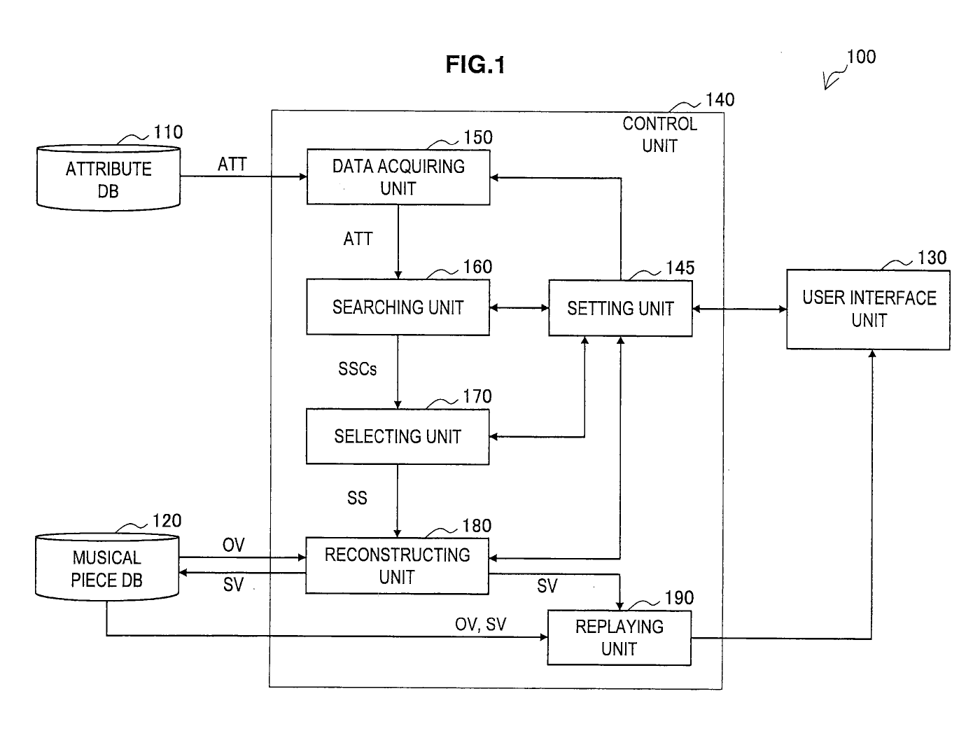

FIG. 1 is a block diagram illustrating an example of a configuration of an information processing apparatus 100 according to the present embodiment. Referring to FIG. 1, the information processing apparatus 100 includes an attribute database (DB) 110, a musical piece DB 120, a user interface unit 130, and a control unit 140.

[1-1. Attribute DB]

The attribute DB 110 is a database configured using a storage medium such as a hard disk or a semiconductor memory. The attribute DB 110 stores attribute data that is prepared on one or more musical pieces in advance. The attribute data represents an attribute of each of a plurality of sections included in each musical piece. Here, the section may be a single bar or a plurality of consecutive bars. In the present embodiment, the attribute data represents a melody type of each section. For example, the melody type represented by the attribute data may include an intro (prelude), an A melody, a B melody, a chorus, a bridge (interlude), an outro (postlude), and the like. In addition to (or instead of) the melody type, the attribute data may represent other attributes such as chords of each section, a key, and the type of a musical instrument being played.

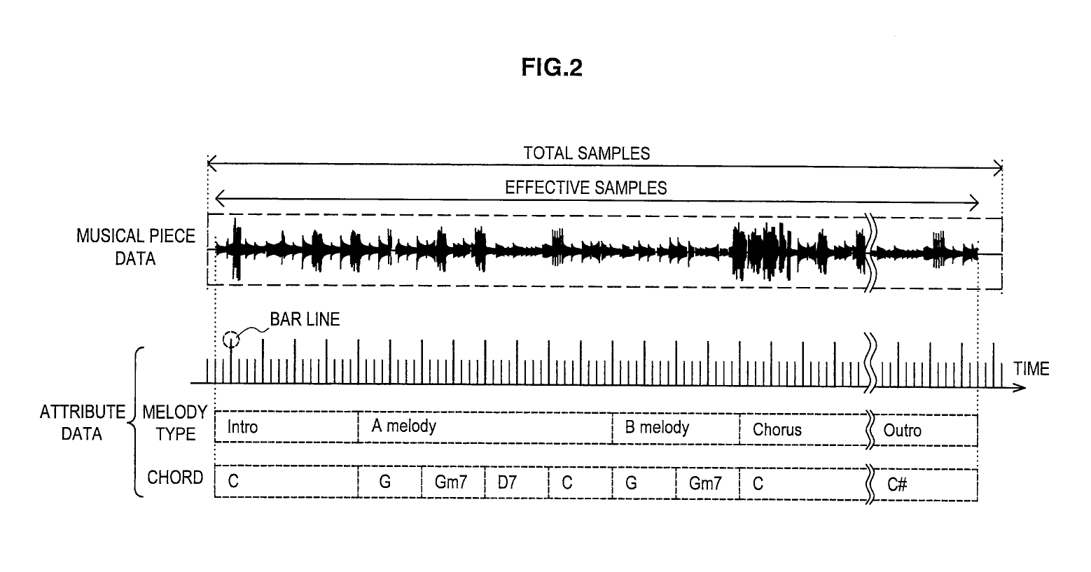

FIG. 2 is an explanatory diagram for describing an example of the structure of the attribute data. On an upper portion of FIG. 2, musical piece data of a certain musical piece is illustrated. The musical piece data is generated such that a waveform of a musical piece according to a time axis is sampled at a predetermined sampling rate, and a sample is encoded. In a single musical piece, the number of effective samples obtained by encoding a practical sound (a speech waveform) may be smaller than the total number of samples.

On a lower portion of FIG. 2, an example of corresponding attribute data is illustrated. A long vertical line in an upper part of the attribute data represents a temporal position of a bar line. A short vertical line represents a beat position. For example, temporal positions of a bar line and a beat may be automatically recognized such that musical piece data is analyzed according to a technique disclosed in JP 2007-248895A. Instead, temporal positions of a bar line and a beat may be manually designated.

A label in a middle part of the attribute data represents a melody type of each section. In the example of FIG. 2, the melody type of zeroth to fourth bars is the intro, the melody type of fifth to twelfth bars is the A melody, the melody type of thirteenth to sixteenth bars is the B melody, the melody type of seventeenth and subsequent bars is the chorus, and the melody type of the last bar is the Outro. A label in a lower portion of the attribute data represents chords of each section. For example, the attributes such as the melody type and the chords may be automatically recognized such that musical piece data is analyzed according to a technique disclosed in JP 2010-122629A. Instead, the user who listens to a musical piece and determines an attribute may manually allocate an attribute to a musical piece.

The attribute DB 110 outputs attribute data ATT of a musical piece (hereinafter referred to as a “target musical piece”) designated as a shortened version generation target to a data acquiring unit 150 which will be described later.

[1-2. Musical Piece DB]

The musical piece DB 120 is also a database configured using a storage medium such as a hard disk or a semiconductor memory. The musical piece DB 120 stores musical piece data of one or more musical pieces. The musical piece data includes waveform data illustrated in FIG. 2. For example, the waveform data may be encoded according to an arbitrary audio coding scheme such as WAVE, MP3 (MPEG Audio Layer-3), or AAC (Advanced Audio Coding). The musical piece DB 120 outputs musical piece data (that is, an original musical piece data) OV that is a non-compressed target musical piece to a reconstructing unit 180 which will be described later. The musical piece DB 120 may additionally store the shortened version SV generated by the reconstructing unit 180.

Either or both of the attribute DB 110 and the musical piece DB 120 may not be a part of the information processing apparatus 100. For example, the databases may be implemented by a data server accessible by the information processing apparatus 100. Further, a removable medium connected to the information processing apparatus 100 may store the attribute data and the musical piece data.

[1-3. User Interface Unit]

The user interface unit 130 provides the user with a user interface through which the user can have access to the information processing apparatus 100 through the information processing apparatus 100 or the terminal device. Various kinds of user interfaces such as a graphical user interface (GUI), a command line interface, a voice UI, or a gesture UI may be used as the user interface provided by the user interface unit 130. For example, the user interface unit 130 may show a list of musical pieces to the user and cause the user to designate a target musical piece that is a shortened version generation target. Further, the user interface unit 130 may cause the user to designate a target value of a time length of a shortened version, that is, a target time length. Hereinafter, some examples of the user interfaces provided by the user interface unit 130 will be described.

[1-4. Control Unit]

The control unit 140 corresponds to a processor such as a central processing unit (CPU) or a digital signal processor (DSP). The control unit 140 executes a program stored in a storage medium to operate various functions of the information processing apparatus 100. In the present embodiment, the control unit 140 includes a setting unit 145, a data acquiring unit 150, a searching unit 160, a selecting unit 170, a reconstructing unit 180, and a replaying unit 190.

(1) Setting Unit

The setting unit 145 sets up processing to be executed by the information processing apparatus 100. For example, the setting unit 145 holds various settings such as an identifier of a target musical piece, a target time length, a selection criterion of a section sequence (which will be described later), and a start section and an end section of a searching process. The setting unit 145 may set a musical piece designated by the user as a target musical piece or may automatically set one or more musical pieces whose attribute data is stored in the attribute DB 110 as target musical pieces. The target time length may be also designated by the user through the user interface unit 130 or may be automatically set. When the service provider desires to provide many shortened versions for trial listening, the target time length may be set in a uniform manner. Meanwhile, when the user desires to generate a shortened version in order to listen to a specific musical piece quickly, the target time length may be designated by the user. The remaining settings will be further described later.

(2) Data Acquiring Unit

The data acquiring unit 150 acquires the attribute data ATT of the target musical piece from the attribute DB 110. As described above with reference to FIG. 2, in the present embodiment, the attribute data ATT represents the melody type of a section configured with one or more bars included in the target musical piece. The data acquiring unit 150 outputs the acquired attribute data ATT to the searching unit 160.

(3) Searching Unit

The searching unit 160 searches each of a plurality of sections of the attribute data ATT for a next section that is temporally adjacent and an alternative section having the same attribute as the next section, and generates a plurality of section sequences. For example, the alternative section may be another section having the same melody type as each next section. The searching process by the searching unit 160 may be executed in the form of a tree using a start section selected from a plurality of sections as a starting point (root) and an end section as an ending point (leaf). The start section may be a section at the beginning of an original musical piece, a first section to which a predetermined melody type (for example, the A melody) is allocated, or a section designated by the user through the user interface unit 130. Similarly, the end section may be a section at the end of an original musical piece, a last section to which a predetermined melody type (for example, a chorus) is allocated, or a section designated by the user through the user interface unit 130.

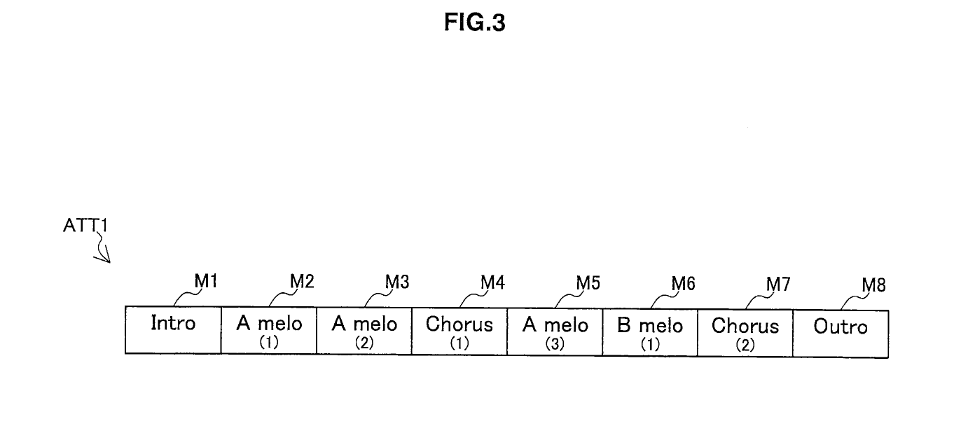

A basic concept of the searching process by the searching unit 160 will be described with reference to FIGS. 3 to 5. Here, as an example, a section at the beginning of an original musical piece is assumed to be set as the start section, and a section at the end of an original musical piece is assumed to be set as the end section.

FIG. 3 illustrates an example of a section sequence of an original musical piece represented by attribute data. Referring to FIG. 3, attribute data ATT1 represents the melody types of eight sections M1 to M8 included in an original musical piece. The melody type of the section M1 is the intro, the melody type of the sections M2, M3, and M5 is an A melody, the melody type of the sections M4 and M7 is a chorus, the melody type of the section M6 is a B melody, and the melody type of the section M8 is the outro. A number in parentheses indicated below the melody type of each section is a number for distinguishing sections having the same melody type from each other.

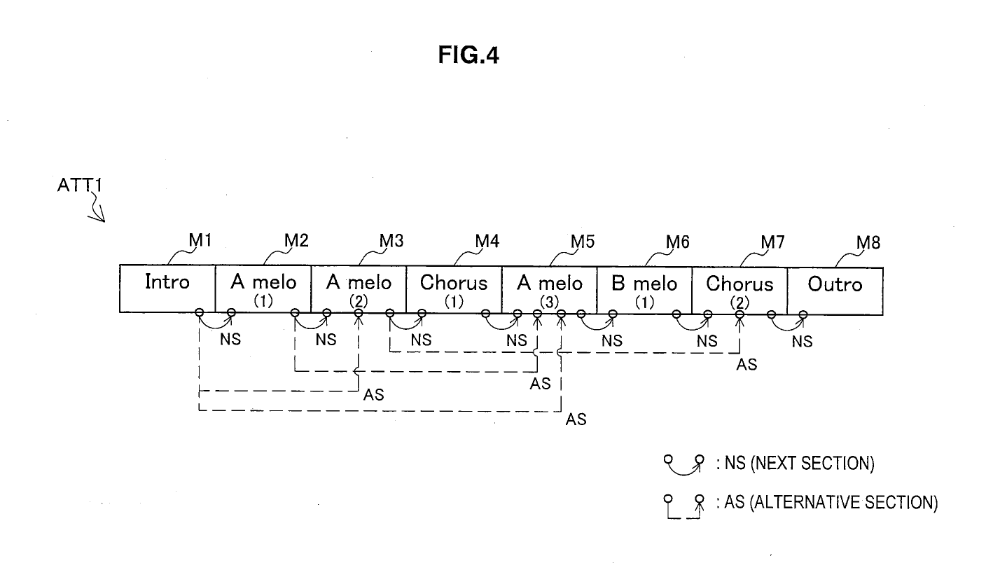

FIG. 4 is an explanatory diagram for describing a next section and an alternative section. Referring to FIG. 4, in the section sequence of the original musical piece illustrated in FIG. 3, a next section (NS) is indicated by an arrow with a solid line, and an alternative section (AS) is indicated by an arrow with a dashed line. For example, the next section to the section M1 is the section M2. The alternative sections of the section M1 are the sections M3 and M5 having the same attribute (the melody type=“A melody”) as the next section M2. The next section of the section M3 is the section M4. The alternative section of the section M3 is the section 7 having the same attribute (the melody type=“chorus”) as the next section M4. When a certain section is used as a current node in the searching process, the next section and the alternative section of the corresponding section are child nodes of the current node. The searching unit 160 executes a search in a tree form according to a relation between nodes recognized from the attribute data ATT1, and generates one or more section sequences corresponding to a branch from a root to a leaf in a tree structure.

Tracking of each branch may be performed until a corresponding branch reaches the end section. When each branch reaches the end section, the searching unit 160 stores a section sequence corresponding to a corresponding branch as a section sequence candidate, and transitions to tracking of another branch. When there is no branch that is not searched yet, the searching process ends.

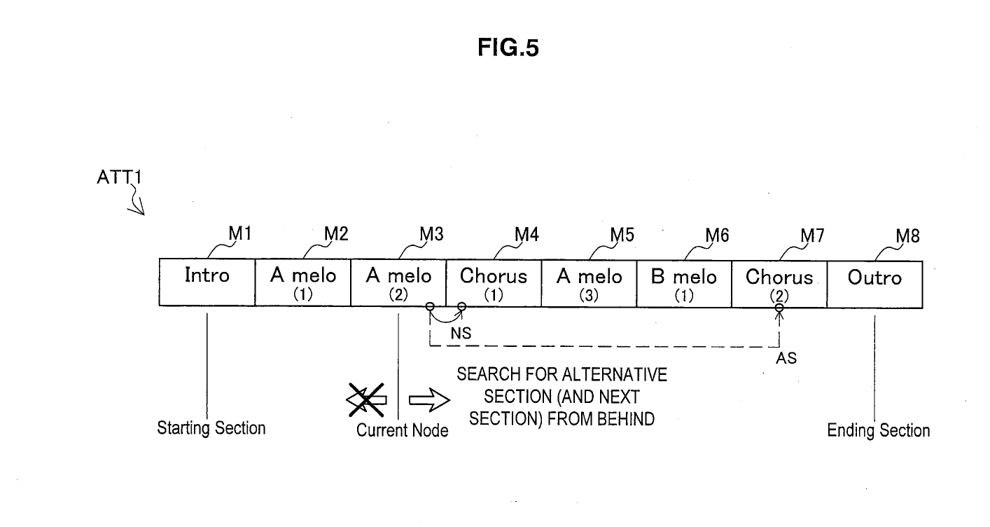

When it is desired to reduce a time length of a musical piece, that is, when a target time length is shorter than a time length of an original musical piece, the searching unit 160 selects a next section of a current node or an alternative section behind a corresponding next section as a child node of a current node in the searching process. An alternative section ahead of a current node is not selected as a child node. This search rule is conceptually illustrated in FIG. 5. This is because when a section ahead of a current node is allowed to be selected as a child node, a time length of a branch increases, the number of branches increases, and thus it takes much time to perform the searching process. The technology according to the present disclosure can be applied to a case in which it is desired to extend a time length of a musical piece instead of shortening a time length of a musical piece. In the case in which it is desired to extend a time length of a musical piece, an alternative section ahead of a current node is allowed to be selected as a child node. This application example will be described later.

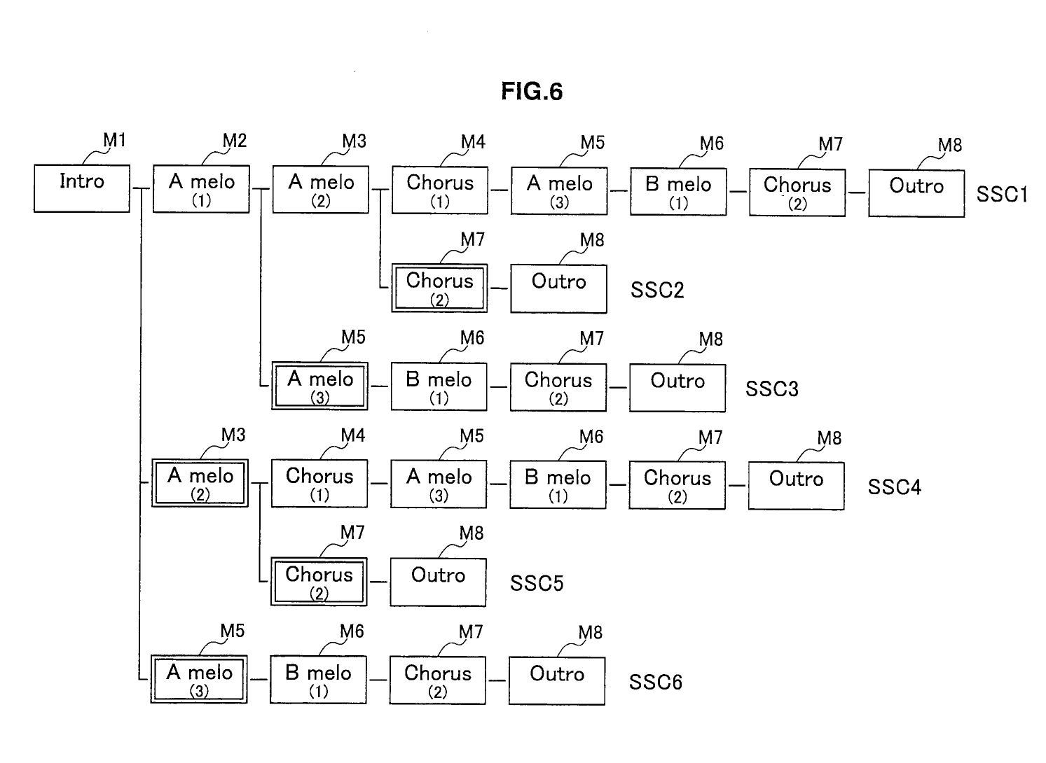

FIG. 6 is an explanatory diagram for describing an example of a section sequence candidate generated based on the section sequence of the original musical piece illustrated in FIG. 3. Referring to FIG. 6, the tree structure having six branches searched using the section M1 as the root (the start section) and the section M8 as the leaf (the end section) is illustrated. The six branches are stored as six section sequence candidates SSC1 to SSC6. The section sequence candidate SSC1 includes the sections M1 to M8 as in the original musical piece. The section sequence candidate SSC2 includes the sections M1, M2, M3, M7, and M8. The section sequence candidate SSC3 includes the sections M1, M2, M5, M6, M7, and M8. The section sequence candidate SSC4 includes the sections M1, M3, M4, M5, M6, M7, and M8. The section sequence candidate SSC5 includes the section M1, M3, M7, and M8. The section sequence candidate SSC6 includes the sections M1, M5, M6, M7, and M8. A section surrounded by a dual frame border in FIG. 6 is a section selected as an alternative section at the time of search.

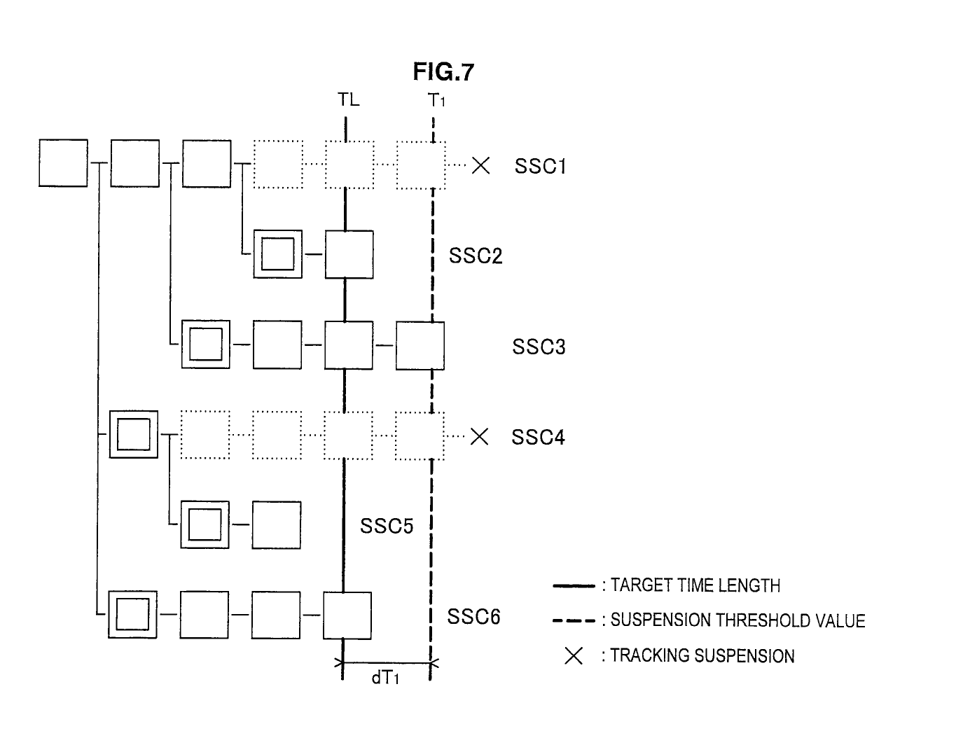

In an actual musical piece, typically, more sections than in the example of FIG. 3 are included. As the number of sections included in an original musical piece increases, the number of section sequence candidates generated as a result of search increases. In this regard, when a time length (a sum of time lengths of sections included in a corresponding section sequence) of a branch that is being tracked exceeds a suspension threshold value, the searching unit 160 may suspend tracking of a corresponding branch. The suspension threshold value is decided according to a target time length set by the setting unit 145. For example, the suspension threshold value may be decided such that a time offset is added to a target time length. FIG. 7 is an explanatory diagram for describing tracking suspension in the searching process. Referring to FIG. 7, a target time length TL and a suspension threshold value T₁ are illustrated by a solid line and a dashed line, respectively, together with the tree structure illustrated in FIG. 6. The suspension threshold value T₁ is a sum of the target time length TL and a time offset dT₁. In the example of FIG. 7, for the section sequence candidate SSC1 and SSC4 in which the time length exceeds the suspension threshold value T₁, a new child node is not selected, and tracking is suspended. The searching unit 160 may exclude a section sequence corresponding to the suspended branch from the section sequence candidate. Instead, the searching unit 160 may include a suspended branch satisfying a certain condition (for example, already including a section having a predetermined melody type) as the section sequence candidate. Through the tracking suspension, vain tracking on a branch that is not appropriate to a target time length can be avoided, and a time necessary for the searching process can be reduced. Further, processor performance and memory capacity necessary for the searching process can be suppressed.

The searching unit 160 outputs one or more section sequence candidates SSCs generated as a result of performing the searching process to the selecting unit 170.

(4) Selecting Unit

The selecting unit 170 selects at least one section sequence SS used to change a time length of a musical piece from section sequence candidates SSCs input from the searching unit 160. The selecting unit 170 may automatically select a section sequence according to a predetermined selection criterion. The selecting unit 170 may show a list of the section sequence candidates to the user through the user interface unit 130 and cause the user to designate a section sequence from which a musical piece is desired to be reconstructed. The section sequence candidates shown to the user may be filtered according to a predetermined selection criterion.

The selection criterion that can be used by the selecting unit 170 is typically a criterion related to a target time length. For example, the selecting unit 170 may preferentially select a section sequence candidate that is small in a time length difference with a target time length. Further, the selecting unit 170 may select a section sequence in view of another evaluation parameter such as the number of alternative sections in each section sequence or the number of sections having a predetermined melody type (for example, a chorus).

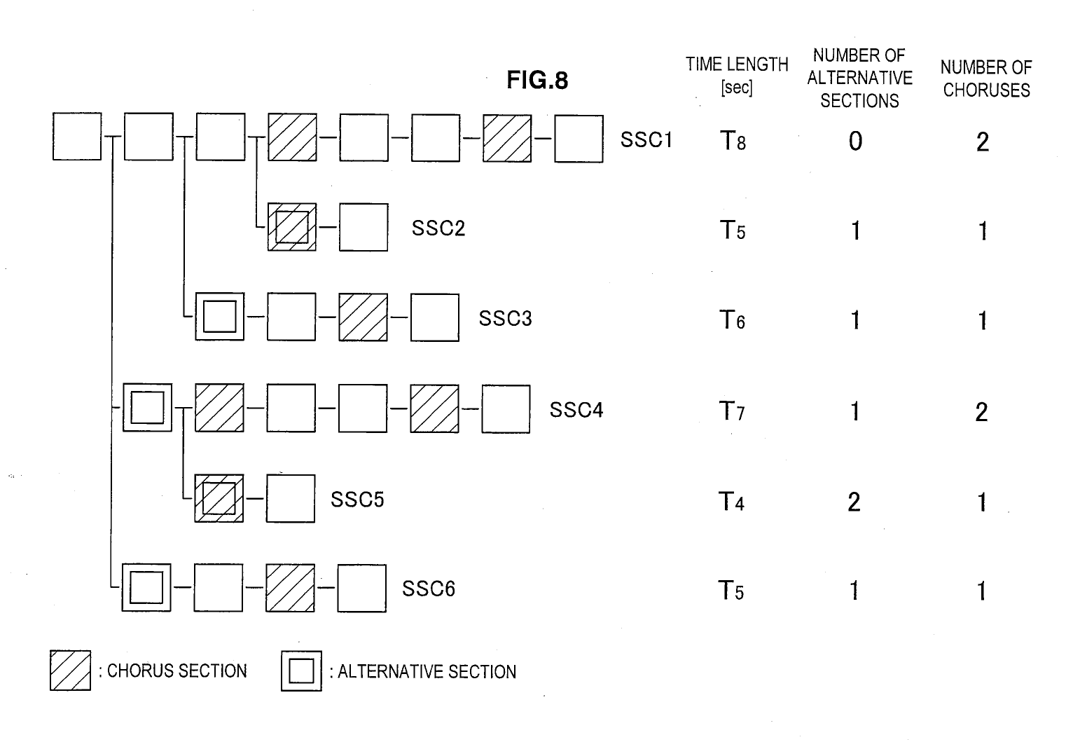

FIG. 8 is an explanatory diagram for describing an example of evaluation parameter values of the section sequence candidates illustrated in FIG. 6. On the left of FIG. 8, the section sequence candidates SSC1 to SSC6 are illustrated. A section surrounded by a dual frame border is an alternative section. A hatched section is a chorus section. On the right of FIG. 8, three evaluation parameter values, that is, a time length, the number of alternative sections, and the number of choruses of each section sequence candidate are illustrated. The section sequence candidate SSC1 has a time length T₈ and includes two chorus sections without including an alternative section. The section sequence candidate SSC2 has a time length T₅ and includes a single alternative section and a single chorus section. The section sequence candidate SSC3 has a time length T₆ and includes a single alternative section and a single chorus section. The section sequence candidate SSC4 has a time length T₇ and includes a single alternative section and two chorus sections. The section sequence candidate SSC5 has a time length T₄ and includes two alternative sections and a single chorus section. The section sequence candidate SSC6 has a time length T₅ and includes a single alternative section and a single chorus section.

It is preferable that a time length be close to a target time length. Since the number of alternative sections corresponds to the number of discontinuous points in a reconstructed version, it is preferable that the number of alternative sections be small. It is preferable that the number of chorus sections be large. In this regard, for example, when a time length difference (with a target time length) of an i-th section sequence candidate is Aᵢ, the number of alternative sections is Bᵢ, and the number of chorus sections is Cᵢ, suitability for reconstruction of a musical piece can be scored by the following Equation (1) for each section sequence candidate. Further, coefficients α, β, and γ may be fixedly defined in advance or may be defined to be adjusted by the user through the user interface unit 130.

$${S}_{i} = \frac{α}{{A}_{i}} + \frac{β}{{B}_{i}} + γ \cdot {C}_{i} \qquad ( 1 )$$

Instead, the selecting unit 170 may calculate a score S′ᵢ of each section sequence candidate by the following Equation (2) on the section sequence candidate in which the time length difference Aᵢ is smaller than a predetermined threshold value T₂.

$${S}_{i}^{′} = \frac{β}{{B}_{i}} + γ \cdot {C}_{i} ( for {A}_{i} < {T}_{2} ) \qquad ( 2 )$$

In both cases, the selecting unit 170 may select a section sequence candidate having the highest calculated score as a section sequence used to reconstruct a musical piece. Instead, the selecting unit 170 may show a list of section sequence candidates (for example, representing top M scores) filtered using the calculated score to the user through the user interface unit 130.

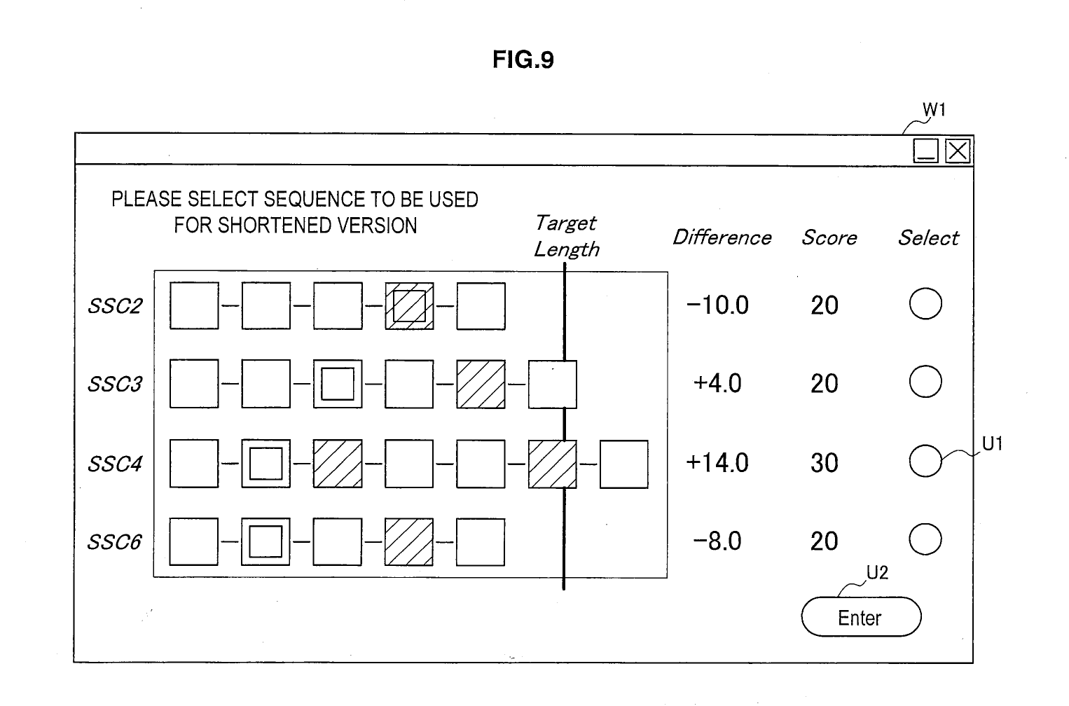

FIG. 9 illustrates a sequence designation window W1 that is an example of a GUI causing the user to designate a section sequence. On the left of the sequence designation window W1, four section sequence candidates SSC2, SSC3, SSC4, and SSC6 filtered by the selecting unit 170 are displayed. On the right of the sequence designation window W1, a time difference and a score of each section sequence candidate are displayed. A check box U1 and a decision button U2 by which the user designates a desired section sequence are also displayed. As the GUI is provided, the user can designate a desired section sequence to be used to reconstruct a musical piece with reference to the displayed information.

The selecting unit 170 outputs the section sequence SS which is automatically selected according to the above-described selection criterion or is selected according to a designation by the user to a reconstructing unit 180.

(5) Reconstructing Unit

The reconstructing unit 180 reconstructs a musical piece corresponding to the section sequence SS input from the selecting unit 170 from the original musical piece. More specifically, the reconstructing unit 180 acquires original musical piece data OV of a target musical piece from the musical piece DB 120. Then, the reconstructing unit 180 extracts parts corresponding to sections included in the section sequence SS from the original musical piece data OV, and connects the extracted parts. When the target time length is shorter than the time length of the original musical piece, a shortened version SV is generated as a result of reconstruction. In an application example which will be described later, when the target time length is longer than the time length of the original musical piece, an extension version may be generated as a result of reconstruction.

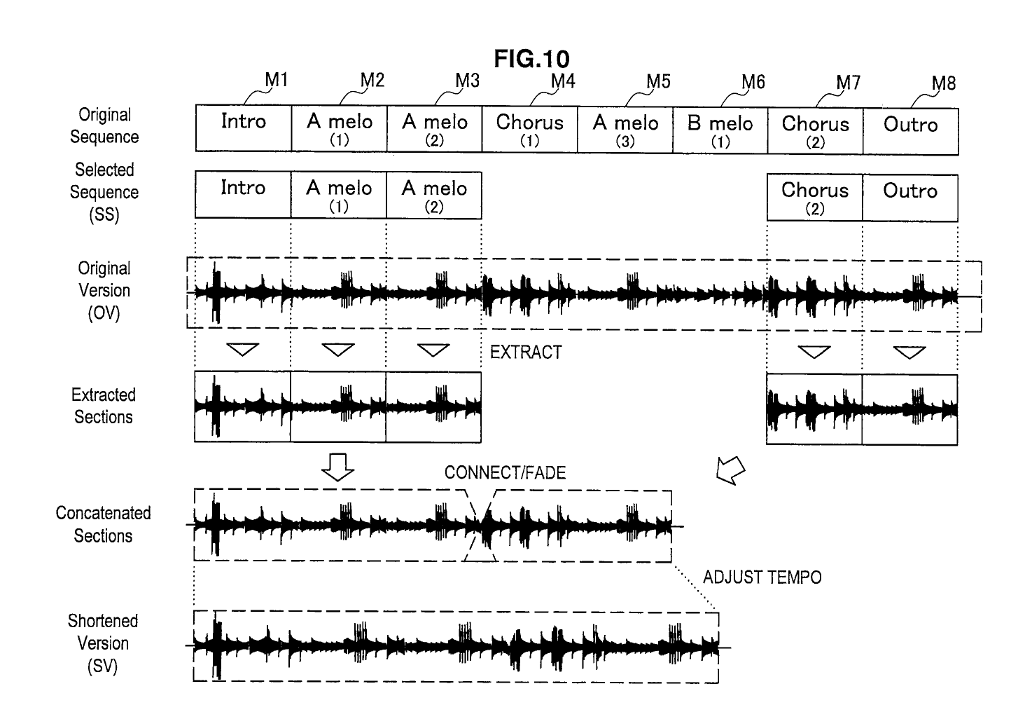

FIG. 10 is an explanatory diagram for describing an example of a reconstruction process according to the present embodiment. On the top tier of FIG. 10, the section sequence of the same original musical piece as illustrated in FIG. 3 is illustrated. On a second tier, the section sequence SS selected by the selecting unit 170 is illustrated. The section sequence SS includes the sections M1, M2, M3, M7, and M8. On a third tier, an example of waveform data included in the original musical piece data OV is illustrated. The reconstructing unit 180 extracts parts corresponding to the section M1, M2, M3, M7, and M8 included in the section sequence SS from the original musical piece data OV (see a fourth tier). A portion between the section M3 and the section M7 is a discontinuous point. Thus, the reconstructing unit 180 connects the section M3 with the section M7 (see a fifth tier). At the time of connection, the reconstructing unit 180 may cross-fade the end of the section M3 and the beginning of the section M7 or may fade out the end of the section M3. As a result, an abrupt change of a sound at the discontinuous point can be mitigated, and factitiousness felt by the user at the time of replay can be reduced. In addition, when the time length of the section sequence SS is not equal to the target time length, the reconstructing unit 180 adjusts the tempo of connected data, and generates the shortened version SV having the time length equal to the target time length (see a sixth tier). Further, when the time length of the connected data is longer than the target time length, the reconstructing unit 180 may fade out the end section in midstream or cause the time length of the shortened version SV to match the target time length, instead of adjusting the tempo.

The shortened version reconstructed by the reconstructing unit 180 as described above includes as many discontinuous points as the number of alternative sections. However, a combination of melody types of two sections before and after a discontinuous point is equivalent to a combination of melody types of consecutive sections in the original musical piece. Thus, compared to the case in which a combination of new melody types before and after a discontinuous point is made, factitiousness arising from a discontinuous point at the time of replay can be avoided or mitigated. Further, a musical progression of a musical piece can be maintained even in a shortened version.

The reconstructing unit 180 may cause the shortened version SV generated as a result of performing the reconstruction process to be stored in the musical piece DB 120. Instead, the reconstructing unit 180 may output the shortened version SV to the replaying unit 190, and cause the replaying unit 190 to replay the shortened version SV. For example, the shortened version SV can be replayed by the replaying unit 190 for trial listening or quick listening or added to a movie as back group music (BGM).

(6) Replaying Unit

The replaying unit 190 replays the musical piece reconstructed from the original musical piece by the reconstructing unit 180. For example, the replaying unit 190 replays the shortened version SV acquired from the musical piece DB 120 or the reconstructing unit 180, and outputs a sound of a reduced musical piece through the user interface unit 130. Further, the shortened version SV may be replayed from the original musical piece data OV using the section sequence SS in real time (for example, by performing a jump replay according to the section sequence SS), instead of being output as a file in advance. This configuration is useful when non-destruction and non-duplication of an original musical piece are desirable. A part (for example, an adjustment of the tempo) of the reconstruction process described above with reference to FIG. 10 may be performed when a musical piece is replayed by the replaying unit 190.

[1-5. Application to Extension of Musical Piece]

As described above, the technology according to the present disclosure can be applied to the case in which it is desired to extend a time length of a musical piece. In the case in which it is desired to extend a time length of a musical piece, in the searching process by the searching unit 160, an alternative section ahead of a current node is allowed to be selected as a child node. More specifically, when the target time length set by the setting unit 145 is longer than the time length of the original musical piece, the searching unit 160 may select a next section of a current node, an alternative section ahead of a current node, and an alternative section behind a next section as a child node of a current node. In a certain branch, when an alternative section ahead of a current node is selected as a child node, the time length of the branch may be longer than the time length of the original musical piece. Typically, selection of an alternative section from ahead is allowed until a time length of a branch that is being tracked exceeds a changeover threshold value that is decided according to the target time length. Here, for example, the changeover threshold value may be decided by reducing a time offset (that may correspond to a certain percentage of a time length of an original musical piece) from the target time length. After the time length of the branch that is being tracked exceeds the changeover threshold value, only a next section and an alternative section from behind can be selected as a child node of a current node in the corresponding branch.

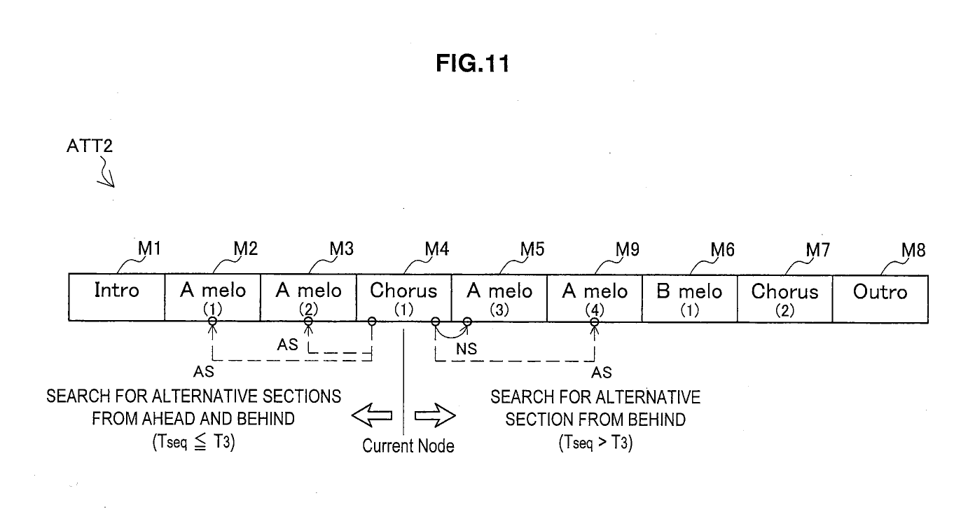

FIG. 11 conceptually illustrates the above-described search rule in the case in which it is desired to extend a time length of a musical piece. In the example of FIG. 11, a current node is positioned at a section M4. When a time length T_{seq} of a branch that is being tracked is shorter than a changeover threshold value T₃, alternative sections M2 and M3 in front of the section M4 are selected as a child node (a next section in a section sequence) of the section M4. However, when the time length T_{seq} of the branch that is being tracked is longer than the changeover threshold value T₃, only a next section M5 of the section M4 and an alternative section M9 behind the section M4 can be selected as a child node of the section M4. Through the changeover of the search range, a time length of a musical piece can be extended, and it is possible to prevent more processing time than necessary from being taken to search a branch.

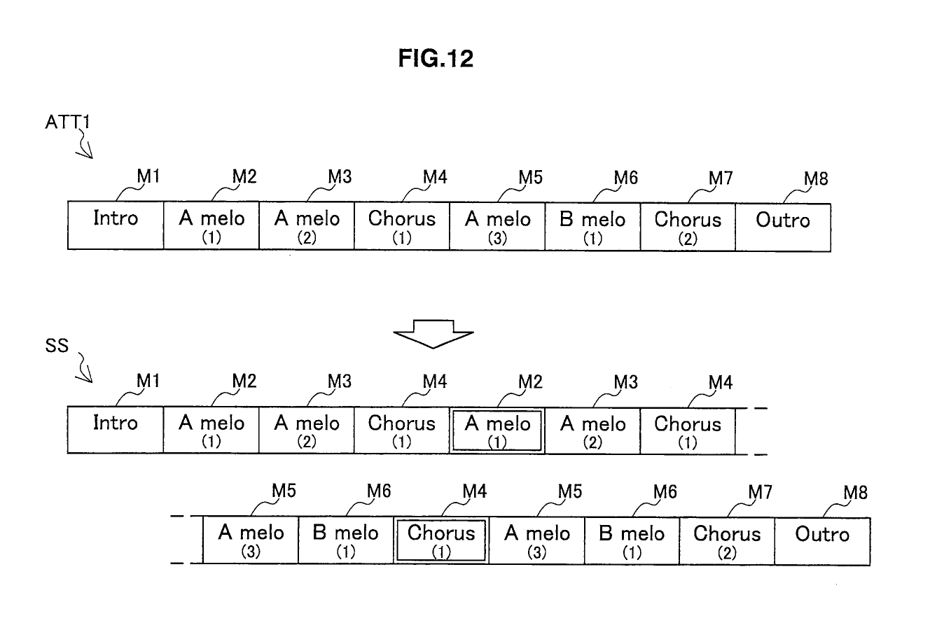

FIG. 12 illustrates an example of a section sequence for an extension version extended based on the section sequence of the original musical piece illustrated in FIG. 3. A section sequence of an original musical piece illustrated on an upper portion of FIG. 12 includes eight sections M1 to M8. On the other hand, in a section sequence SS illustrated on a lower portion of FIG. 12, the alternative section M2 (that is ahead of the section M4 in the original musical piece) is positioned behind the section M4 that appears for the first time. Further, the alternative section M4 (that is ahead of the section M6 in the original musical piece) is positioned behind the section M6 that appears for the first time. As a result, the section sequence SS includes 14 sections such that its time length is longer than a time length of the original musical piece.

The extension version reconstructed by the reconstructing unit 180 using the section sequence extended as described above includes as many discontinuous points as the number of alternative sections. However, in this case, a combination of new melody types before and after a discontinuous point is not made. Thus, factitiousness arising from a discontinuous point at the time of replay can be avoided or mitigated. A musical progression of a musical piece is also maintained in an extension version.

In this disclosure, the description has been made in connection with the example in which the searching process is executed mainly based on the melody type, but the searching process may be executed based on an attribute of a different type such as a chord.

### 2. Example of Flow of Process According to Embodiment

[2-1. General Flow]

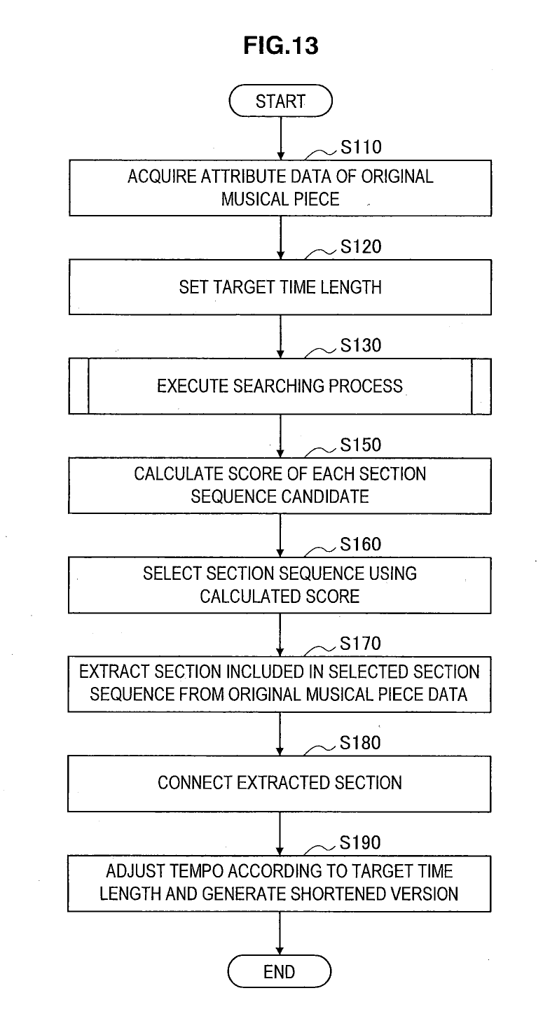

FIG. 13 is a flowchart illustrating an example of a general flow of a process executed by the information processing apparatus 100 according to the present embodiment.

Referring to FIG. 13, first of all, the data acquiring unit 150 acquires attribute data representing a melody type of each of a plurality of sections included in a target musical piece (step S110). Then, the setting unit 145 sets a target time length for the target musical piece (step S120).

Next, the searching unit 160 executes the searching process using the attribute data acquired by the data acquiring unit 150 (step S130). The searching process to be executed here will be described in detail later. The searching unit 160 generates a plurality of section sequence candidates as a result of executing the searching process.

Next, the selecting unit 170 calculates a score on each section sequence candidate generated by the searching unit 160 (step S150). The score to be calculated here may be a simple time difference between the time length of each section sequence candidate and the target time length or may be an advanced score calculated by Equation (1) or (2).

Next, the selecting unit 170 selects a section sequence used to reconstruct a musical piece using the score calculated in step S150 (step S160). The selecting unit 170 may automatically select the section sequence according to the score of each section sequence candidate or may cause the user to designate the section sequence to be selected.

Next, the reconstructing unit 180 extracts parts corresponding to sections included in the section sequence selected in step S160 from the original musical piece data (step S170). Next, the reconstructing unit 180 connects the parts extracted from the original musical piece data (step S180). Then, the reconstructing unit 180 adjusts the tempo of the connected data according to the target time length, and generates a shortened version (step S190).

[2-2. Searching Process]

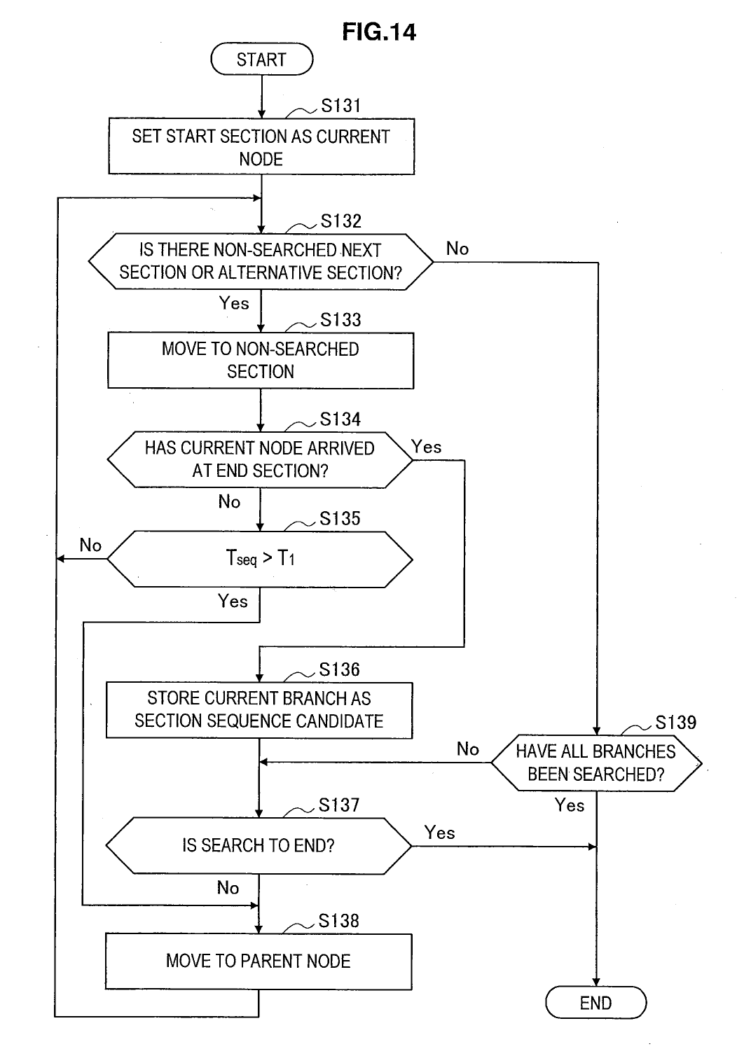

FIG. 14 is a flowchart illustrating an example of a detailed flow of the searching process illustrated in FIG. 13. Here, the flow of a process according to a depth-first search technique will be described, but the present disclosure is not limited to this example, and the searching process may be performed according to a breadth-first search technique or a search technique of any other type.

Referring to FIG. 14, first of all, the searching unit 160 searches for a start section as a current node (step S131). Here, the start section may be a section at the beginning of an original musical piece or any other section.

Next, the searching unit 160 determines whether or not the current node has a next section or an alternative section which has not been searched yet (step S132). When it is determined the current node has a next section or an alternative section which has not been searched yet, the searching unit 160 moves a current node to any section (a child node of a current node) which has not been searched yet (step S133). Next, the searching unit 160 determines whether or not the current node has arrived at the end section (step S134). When it is determined that the current node has not arrived at the end section, the searching unit 160 compares the time length T_{seq} of the branch that is being searched with the suspension threshold value T₁ (step S135). When the time length T_{seq} of the branch that is being searched exceeds the suspension threshold value T₁, the tracking of the branch is suspended, and the process proceeds to step S138. When the time length T_{seq} of the branch that is being searched does not exceed the suspension threshold value T₁, the tracking of the branch is continued, and the process proceeds to step S132. When it is determined in step S134 that the current node has arrived at the end section, the searching unit 160 stores the current branch as one of the section sequence candidates (step S136). Then, the process proceeds to step S137.

In step S137, the searching unit 160 determines whether or not the searching process is to end. For example, when a processing time exceeding a predetermined upper limit from the start of search elapses or when the number of section sequence candidates reaches a predetermined upper limit, the searching unit 160 may end the searching process midstream. When it is determined that the searching process is not to end, the process proceed to step S138.

In step S138, since the time length T_{seq} of the branch that is being searched exceeds the suspension threshold value T₁ or the current node has arrived at the end section, the searching unit 160 causes the current node to move to a parent node. Moving to the parent node is repeated until the current node has a next section or an alternative section which has not been searched yet.

Then, when an end condition is satisfied in step S137 or when all branches excluding the suspended branch have been searched (step S139), the searching unit 160 ends the searching process.

### 3. First Modified Example

The technology according to the present disclosure can be applied to the purpose of quickly listening to a plurality of musical pieces together as well as the purpose of trial listening of an individual musical piece, quick listening, or addition of BGM to a movie. For example, a set of musical pieces is assumed to be defined in advance like a musical piece album or a playlist. The user may desire to listen to all of a set of musical pieces within a limited time in various situations such as while commuting, going to school, driving, eating, or bathing. In a first modified example described in this section, a system satisfying such needs is provided.

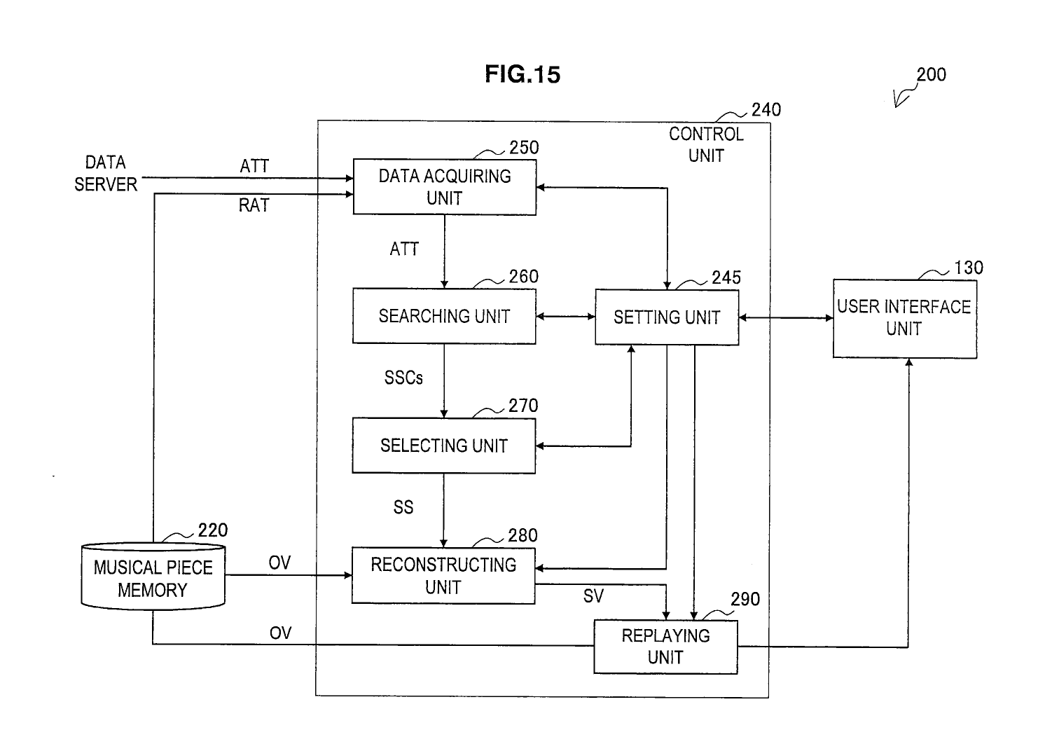

FIG. 15 is a block diagram illustrating an example of a configuration of an information processing apparatus 200 according to the first modified example. Referring to FIG. 15, the information processing apparatus 200 includes a musical piece memory 220, a user interface unit 130, and a control unit 240.

[3-1. Musical Piece Memory]

The musical piece memory 220 is a storage medium that stores musical piece data of a plurality of musical pieces configuring a set of musical pieces such as a musical piece album or a playlist. In addition to the musical piece data, the musical piece memory 220 may store rating data representing a rating of each musical piece. The rating of each musical piece may be decided based on various factors such as the number of replay times of a corresponding musical piece or other similar musical pieces, the user's preference, or a recommendation from the service provider or the user. The musical piece memory 220 outputs original musical piece data OV of one or more target musical pieces selected by a setting unit 245 among a plurality of musical pieces to a reconstructing unit 280. Further, the musical piece memory 220 outputs rating data RAT of the target musical piece to the data acquiring unit 250.

[3-2. Control Unit]

The control unit 240 corresponds to a processor such as a CPU or a DSP. The control unit 240 executes a program stored in a storage medium, and operates various functions of the information processing apparatus 200. In the present embodiment, the control unit 240 includes the setting unit 245, the data acquiring unit 250, a searching unit 260, a selecting unit 270, the reconstructing unit 280, and a replaying unit 290.

(1) Setting Unit

The setting unit 245 sets up a process executed by the information processing apparatus 200. For example, the setting unit 245 holds various settings such as a list of identifiers of target musical pieces, a total target time length, a target time length of each target musical piece, and a selection criterion of a section sequence. The setting unit 245 sets all of a plurality of musical pieces configuring a set of musical pieces as target musical pieces. Instead, the setting unit 245 may set some musical piece to be reconstructed as a target musical piece. For example, the setting unit 245 may select a musical piece to be set as a target musical piece based on a rating represented by the rating data RAT on each of a plurality of musical pieces.

The total target time length may be designated by the user through the user interface unit 130. For example, the user may designate a total target time length necessary to listen to a set of musical pieces according to a time necessary for commuting, going to school, or the like. The setting unit 245 calculates a target time length of each musical piece to be reconstructed based on the designated total target time length.

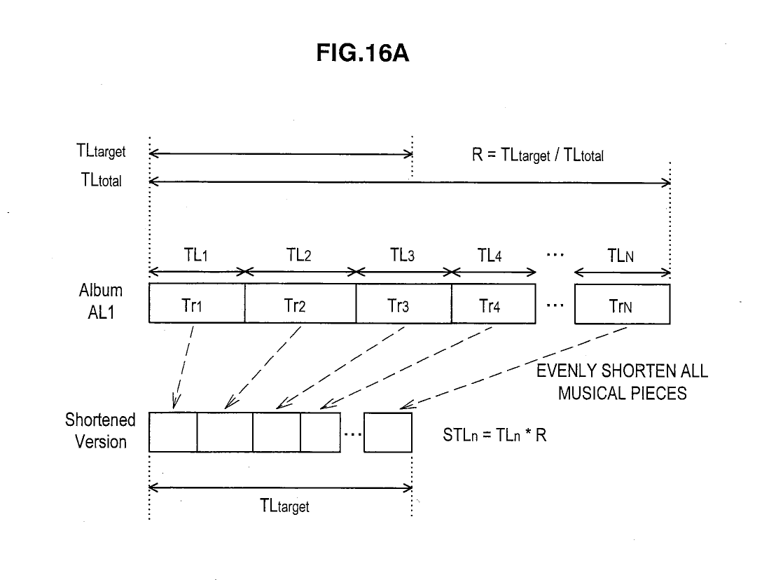

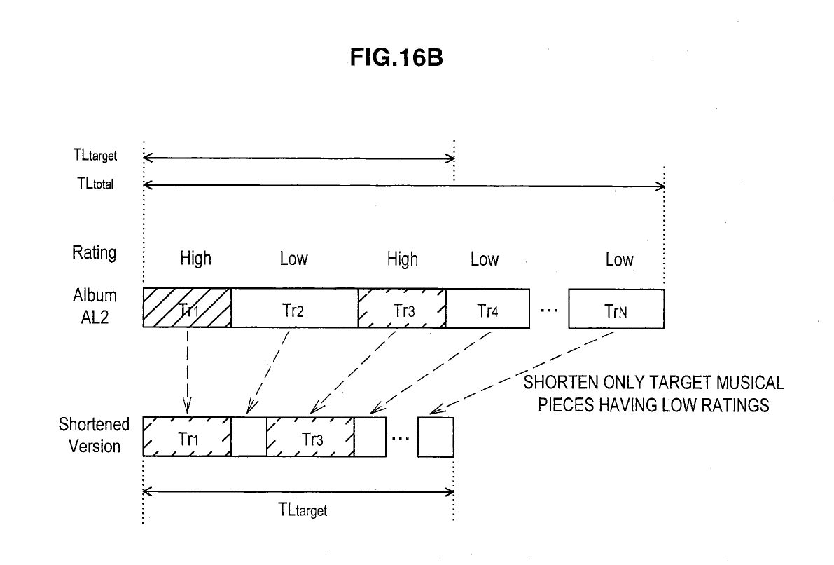

FIG. 16A is an explanatory diagram for describing a first example of a time length calculation process by the setting unit 245. FIG. 16A conceptually illustrates an album AL1 including N tracks Tr₁ to Tr_{N} having a time length TLₙ (n=1, . . . , N). A total time length TLₜₒₜₐₗ is a time length of the entire album AL1. A ratio R is a ratio of a total target time length TL_{target} to the total time length TLₜₒₜₐₗ (R=TL_{target}/TLₜₒₜₐₗ). In the first example, the setting unit 245 sets all tracks configuring the album AL1 as the target musical piece. The setting unit 245 calculates a target time length STLₙ of a target musical piece Trₙ by multiplying the time length TLₙ of each original musical piece by the ratio R (STLₙ=TLₙ×R).

FIG. 16B is an explanatory diagram for describing a second example of the time length calculation process by the setting unit 245. FIG. 16B conceptually illustrates an album AL2 including N tracks Tr₁ to Tr_{N} having a time length TLₙ (n=1, . . . , N). A rating is given to each track of the album AL2. For example, a rating of the tracks Tr₁ and Tr₃ is higher than a rating of the other tracks. In this regard, in the second example, the setting unit 245 sets tracks other than the track Tr₁ and Tr₃ having the high rating as the target musical pieces whose time length is to be shortened. Meanwhile, the setting unit 245 excludes the tracks Tr₁ and Tr₃ from being the target musical pieces, and does not recue the tracks. According to the second example, for a musical piece preferred by the user (or a musical piece expected to be preferred by the user), the whole musical piece can be replayed, whereas a shortened version can be replayed for other musical pieces. The setting unit 245 may change a target time length of each target musical piece according to a rating.

(2) Data Acquiring Unit

The data acquiring unit 250 acquires the attribute data ATT of each target musical piece set by the setting unit 245. In the example of FIG. 15, the attribute data ATT is acquired from an external data server. Then, the data acquiring unit 250 outputs the acquired attribute data ATT to the searching unit 260. However, the present disclosure is not limited to this example, and the attribute data ATT may be stored in the musical piece memory 220 or any other storage medium. Further, the data acquiring unit 250 may acquire the rating data RAT of each target musical piece from the musical piece memory 220 and output the rating data RAT to the setting unit 245.

(3) Searching Unit

The searching unit 260 executes the searching process described above with reference to FIGS. 3 to 5 on each piece of attribute data input from the data acquiring unit 250. As a result, the section sequence candidate set SSCs illustrated in FIG. 6 is generated for each target musical piece set by the setting unit 245.

(4) Selecting Unit

The selecting unit 270 selects the section sequence SS from the section sequence candidate SSCs for each target musical piece, similarly to the selecting unit 170 illustrated in FIG. 1. The selection of the section sequence SS may be performed based on any evaluation parameter value such as the time length difference with the target time length, the number of alternative sections, or the number of chorus sections. An evaluation parameter to be preferentially used may be designated by the user. Typically, the selecting unit 270 selects the section sequence SS of each target musical piece so that a total time length of a set of musical pieces that may include a shortened version of a target musical piece and an original version of a non-target musical piece is close to a total target time length. Then, the selecting unit 270 outputs the selected section sequence SS of each target musical piece to the reconstructing unit 280.

(5) Reconstructing Unit

The reconstructing unit 280 reconstructs a musical piece corresponding to the section sequence SS input from the selecting unit 270 from an original musical piece on each target musical piece, similarly to the reconstructing unit 180 illustrated in FIG. 1. More specifically, the reconstructing unit 280 acquires the original musical piece data OV of each target musical piece from the musical piece memory 220. Then, the reconstructing unit 280 acquires parts corresponding to sections included in the section sequence SS from the original musical piece data OV, and connects the extracted parts to generate the shortened version SV of the target musical piece. The shortened version SV of each target musical piece generated by the reconstructing unit 280 is output to the replaying unit 290.

(6) Replaying Unit

The replaying unit 290 acquires the shortened version SV of the target musical piece (which is a target to be shortened) among a set of musical pieces to be listened to quickly from the reconstructing unit 280. Further, the replaying unit 290 acquires an original version OV of the non-target musical piece from the musical piece memory 220. Then, the replaying unit 290 sequentially replays the shortened version SV of the musical piece or the original version OV according to the order of the set of musical pieces, and a sound of each musical piece through the user interface unit 130.

According to the first modified example, a set of musical pieces such as a musical piece album or a playlist can be replayed in a limited time in a digest replay manner. In other words, in various situations of lives, a style of new music experience of listening to a desired set of musical pieces according to a replay time desired by the user can be implemented. For example, the user can be readily aware of all of a set of musical pieces without stopping the digest replay midstream using a time for commuting to work or going to school.

### 4. Second Modified Example

In the technology according to the present disclosure, the device executing the searching process using the attribute data is not necessarily the same as the device reconstructing a musical piece. In this section, a second modified example will be described in connection with an example in which the searching process is executed in the server device, and the reconstruction process is executed in the terminal device.

[4-1. Server Device]

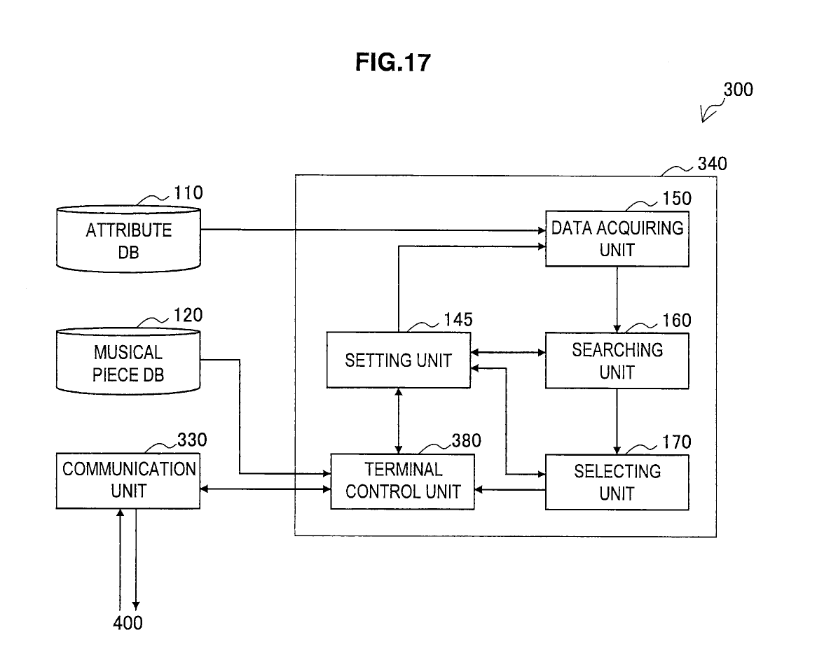

FIG. 17 is a block diagram illustrating an example of a configuration of a server device 300 according to the second modified example. Referring to FIG. 17, the server device 300 includes an attribute DB 110, a musical piece DB 120, a communication unit 330, and a control unit 340. The control unit 340 includes a setting unit 145, a data acquiring unit 150, a searching unit 160, a selecting unit 170, and a terminal control unit 380.

The communication unit 330 is a communication interface performing communication with a terminal device 400 which will be described later.

The terminal control unit 380 causes the setting unit 145 to set a target musical piece according to a request from the terminal device 400, and causes the selecting unit 170 to select a section sequence to be used to reconstruct the target musical piece from one or more section sequence candidates generated by the searching unit 160. Then, the terminal control unit 380 transmits section sequence data specifying the section sequence selected on the target musical piece to the terminal device 400 through the communication unit 330. For example, the section sequence data may be data identifying a starting point and an ending point of a section to be extracted from an original musical piece. When the terminal device 400 does not include the musical piece data of the target musical piece data (that is, the original musical piece data), the terminal control unit 380 may transmit the original musical piece data acquired from the musical piece DB 120 to the terminal device 400 through the communication unit 330.

[4-2. Terminal Device]

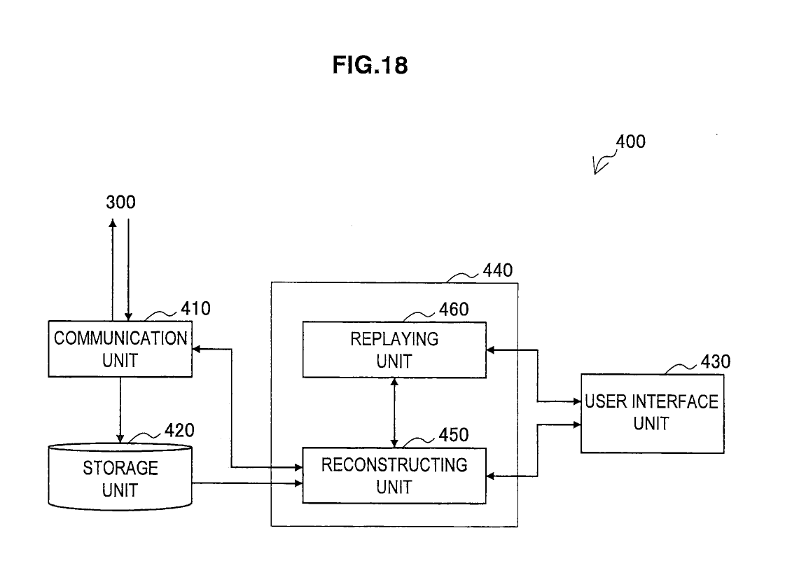

FIG. 18 is a block diagram illustrating an example of a configuration of the terminal device 400 according to the second modified example. Referring to FIG. 18, the terminal device 400 includes a communication unit 410, a storage unit 420, a user interface unit 430, and a control unit 440. The control unit 440 includes a reconstructing unit 450 and a replaying unit 460.

The communication unit 410 is a communication interface performing communication with the server device 300. The communication unit 410 receives the section sequence data and the original musical piece data as necessary from the server device 300.

The storage unit 420 stores data received by the communication unit 410. The storage unit 420 may store the original musical piece data in advance.

The user interface unit 430 provides the user using the terminal device 400 with a user interface. For example, the user interface provided by the user interface unit 430 may include a GUI causing the user to designate a target musical piece and a target time length.

The reconstructing unit 450 requests the server device 300 to transmit section sequence data to be used to reconstruct the target musical piece according to an instruction from the user input through the user interface unit 430. Then, upon receiving the section sequence data from the server device 300, the reconstructing unit 450 reconstructs the target musical piece. More specifically, the reconstructing unit 450 acquires original musical piece data of the target musical piece from the storage unit 420. Then, the reconstructing unit 450 extracts parts corresponding to sections specified by the section sequence data from the original musical piece data, and connects the extracted parts to generate a shortened version of the target musical piece. The shortened version of the target musical piece generated by the reconstructing unit 450 is output to the replaying unit 460.

The replaying unit 460 acquires the shortened version of the target musical piece from the reconstructing unit 450, and replays the acquired shortened version.

### 5. Conclusion

The various embodiments of the technology according to the present disclosure have been described in detail so far. According to the above embodiments, for each of a plurality of sections included in an original musical piece, a next section and an alternative section having the same attribute as the next section are searched for, and a plurality of section sequences are generated. Then, at least one section sequence that may be used to reconstruct a musical piece is selected from the plurality of section sequences. According to this configuration, when a shortened version of a musical piece is generated using the selected section sequence, a combination of new melody types (or other attribute values) that is not in an original musical piece is not made before or after a discontinuous point. Thus, when a shortened version is replayed, factitiousness arising from a discontinuous point can be avoided, or such factitiousness can be reduced.

Further, according to the above embodiments, a progression of a melody type in a shortened version is reproduced in the form similar to a progression of a melody type in an original musical piece. Thus, a musical progression of a musical piece such as developmental structure can be maintained even in a shortened version. For example, when the technology according to the present disclosure is applied in order to generate a version for trial listening provided in a musical piece delivery service, since features of a musical piece can be more accurately provided to the user through a version for trial listening, the user's willingness to buy can be efficiently stimulated.

Further, according to the above embodiments, since a musical piece is reconstructed in units of single or more bars included in an original musical piece, a feeling of beats important to maintain musicality is not damaged even at a discontinuous point. Thus, a reconstructed musical piece can be more naturally replayed.

Further, according to the above embodiments, a section sequence having a time length close to a target time length of a musical piece is selected in order to reconstruct a musical piece. Thus, versions having various time lengths can be generated according to various needs such as generation for a version for trial listening, generation for quick listening, addition of BGM to a movie, and the like. Further, when a section sequence is selected based on the number of alternative sections, the number of discontinuous points in a reconstructed version can be suppressed, and a more natural version can be provided. Further, when a section sequence is selected based on the number of characteristic sections (for example, the number of chorus sections), it is possible to more reliably cause a characteristic part of a musical piece to remain in a reconstructed version.

In addition, according to the above embodiments, since a plurality of sections included in a musical piece can be searched in the form of a tree, the technology according to the present disclosure can be easily implemented using various existing search algorithms. Further, since a search can be suspended based on a threshold value decided according to a target time length, more time than necessary can be prevented from being taken for the searching process. Further, a search can be executed even in a device having no processor performance and memory capacity as in a high-end computer. Furthermore, since a setting of a start section and an end section of a search can be changed, an unnecessary section (for example, the intro or the outro) can be flexibly excluded depending on a version to be reconstructed.

Further, according to the above embodiments, a time length of a musical piece can be reduced, and further can be extended. Thus, for example, even when the user desires a replay to be performed during a time longer than in an original musical piece (for example, when BGM is added to a long movie), the technology according to the present disclosure is useful.

A series of control process by each device described in this disclosure may be implemented using software, hardware, or a combination of software and hardware. For example a program configuring software is stored in a storage medium installed inside or outside each device in advance. Further, for example, each program is read to a random access memory (RAM) at the time of execution and then executed by a processor such as a CPU.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)
An information processing apparatus, including:

a searching unit that searches each of a plurality of sections included in an original musical piece for a next section that is temporally adjacent in the original musical piece and an alternative section having a same attribute as the next section, and generates a plurality of section sequences; and

a selecting unit that selects at least one section sequence from the plurality of section sequences.

(2)
The information processing apparatus according to (1), further including

a data acquiring unit that acquires attribute data representing a melody type of each of the plurality of sections,

wherein the searching unit searches for another section having a same melody type as each next section as the alternative section using the attribute data.

(3)
The information processing apparatus according to (2), further including

a setting unit that sets a target time length of a musical piece to be reconstructed from the original musical piece,

wherein the selecting unit selects the at least one section sequence based on a difference between a time length of each section sequence and the target time length.

(4)
The information processing apparatus according to (3),

wherein the selecting unit selects the at least one section sequence further based on how many the alternative sections are in each section sequence.

(5)
The information processing apparatus according to (3) or (4),

wherein the selecting unit selects the at least one section sequence further based on how many the sections having a predetermined melody type are in each section sequence.

(6)
The information processing apparatus according to any one of (3) to (5),

wherein the searching unit searches for the next section and the alternative section in a tree form using as a starting point a start section selected from the plurality of sections.

(7)
The information processing apparatus according to (6),

wherein, when a time length of a section sequence that is being searched exceeds a first threshold value decided according to the target time length, the searching unit suspends a search of the section sequence that is being searched.

(8)
The information processing apparatus according to (6) or (7),

wherein, when the target time length is shorter than a time length of the original musical piece, the searching unit searches for, as the alternative section, a section that has the same attribute as each next section and is behind the next section.

(9)
The information processing apparatus according to any one of (6) to (8),

wherein, when the target time length is longer than a time length of the original musical piece, the searching unit searches for, as the alternative section, a section that has the same attribute as each next section and is ahead of or behind the next section.

(10)
The information processing apparatus according to (9),

wherein the searching unit does not search the section sequence that is being searched, for the alternative section from ahead, after the time length of the section sequence that is being searched exceeds a second threshold value decided according to the target time length.

(11)
The information processing apparatus according to any one of (3) to (10),

wherein the setting unit causes a user to designate the target time length through a user interface.

(12)
The information processing apparatus according to any one of (3) to (10),

wherein the setting unit calculates the target time length of the original musical piece based on a total target time length of a plurality of musical pieces including the original musical piece.

(13)
The information processing apparatus according to (12),

wherein the setting unit sets one or more musical pieces to be reconstructed among the plurality of musical pieces as a target musical piece, and

wherein the searching unit executes a search for attribute data of each of the set one or more target musical pieces.

(14)
The information processing apparatus according to (13),

wherein the setting unit selects the target musical piece based on a rating given to each of the plurality of musical pieces.

(15)
The information processing apparatus according to any one of (1) to (14), further including

a reconstructing unit that reconstructs a musical piece corresponding to the at least one section sequence selected by the selecting unit from the original musical piece.

(16)
The information processing apparatus according to (15),

wherein the reconstructing unit extracts a section included in each selected section sequence from the original musical piece, and reconstructs a musical piece corresponding to each section sequence.

(17)
The information processing apparatus according to claim any one of (1) to (14), further including

a communication unit that transmits section sequence data specifying the at least one section sequence to a device that reconstructs a musical piece corresponding to the at least one section sequence from the original musical piece.

(18)
The information processing apparatus according to any one of (1) to (17),

wherein each of the plurality of sections is configured with one or more bars included in the original musical piece.

(19)
An information processing method executed by a control unit of an information processing apparatus, the information processing method including:

searching each of a plurality of sections included in an original musical piece for a next section that is temporally adjacent in the original musical piece and an alternative section having a same attribute as the next section, and generating a plurality of section sequences; and

selecting at least one section sequence from the plurality of section sequences.

(20)
A program for causing a computer controlling an information processing apparatus to function as:

a searching unit that searches each of a plurality of sections included in an original musical piece for a next section that is temporally adjacent in the original musical piece and an alternative section having a same attribute as the next section, and generates a plurality of section sequences; and

a selecting unit that selects at least one section sequence from the plurality of section sequences.

The present disclosure contains subject matter related to that disclosed in Japanese Priority Patent Application JP 2012-146545 filed in the Japan Patent Office on Jun. 29, 2012, the entire content of which is hereby incorporated by reference.

What is claimed is:

1. An information processing apparatus, comprising:
a searching unit that searches each of a plurality of sections included in an original musical piece for a next section that is temporally adjacent in the original musical piece and an alternative section having a same attribute as the next section, and generates a plurality of section sequences; and
a selecting unit that selects at least one section sequence from the plurality of section sequences.

2. The information processing apparatus according to claim 1, further comprising
a data acquiring unit that acquires attribute data representing a melody type of each of the plurality of sections,
wherein the searching unit searches for another section having a same melody type as each next section as the alternative section using the attribute data.

3. The information processing apparatus according to claim 2, further comprising
a setting unit that sets a target time length of a musical piece to be reconstructed from the original musical piece,
wherein the selecting unit selects the at least one section sequence based on a difference between a time length of each section sequence and the target time length.

4. The information processing apparatus according to claim 3,
wherein the selecting unit selects the at least one section sequence further based on how many the alternative sections are in each section sequence.

5. The information processing apparatus according to claim 3,
wherein the selecting unit selects the at least one section sequence further based on how many the sections having a predetermined melody type are in each section sequence.

6. The information processing apparatus according to claim 3,
wherein the searching unit searches for the next section and the alternative section in a tree form using as a starting point a start section selected from the plurality of sections.

7. The information processing apparatus according to claim 6,
wherein, when a time length of a section sequence that is being searched exceeds a first threshold value decided according to the target time length, the searching unit suspends a search of the section sequence that is being searched.

8. The information processing apparatus according to claim 6,
wherein, when the target time length is shorter than a time length of the original musical piece, the searching unit searches for, as the alternative section, a section that has the same attribute as each next section and is behind the next section.

9. The information processing apparatus according to claim 6,
wherein, when the target time length is longer than a time length of the original musical piece, the searching unit searches for, as the alternative section, a section that has the same attribute as each next section and is ahead of or behind the next section.

10. The information processing apparatus according to claim 9,
wherein the searching unit does not search the section sequence that is being searched, for the alternative section from ahead, after the time length of the section sequence that is being searched exceeds a second threshold value decided according to the target time length.

11. The information processing apparatus according to claim 3,
wherein the setting unit causes a user to designate the target time length through a user interface.

12. The information processing apparatus according to claim 3,
wherein the setting unit calculates the target time length of the original musical piece based on a total target time length of a plurality of musical pieces including the original musical piece.

13. The information processing apparatus according to claim 12,
wherein the setting unit sets one or more musical pieces to be reconstructed among the plurality of musical pieces as a target musical piece, and
wherein the searching unit executes a search for attribute data of each of the set one or more target musical pieces.

14. The information processing apparatus according to claim 13,
wherein the setting unit selects the target musical piece based on a rating given to each of the plurality of musical pieces.

15. The information processing apparatus according to claim 1, further comprising
a reconstructing unit that reconstructs a musical piece corresponding to the at least one section sequence selected by the selecting unit from the original musical piece.

16. The information processing apparatus according to claim 15,
wherein the reconstructing unit extracts a section included in each selected section sequence from the original musical piece, and reconstructs a musical piece corresponding to each section sequence.

17. The information processing apparatus according to claim 1, further comprising
a communication unit that transmits section sequence data specifying the at least one section sequence to a device that reconstructs a musical piece corresponding to the at least one section sequence from the original musical piece.

18. The information processing apparatus according to claim 1,
wherein each of the plurality of sections is configured with one or more bars included in the original musical piece.

19. An information processing method executed by a control unit of an information processing apparatus, the information processing method comprising:
searching each of a plurality of sections included in an original musical piece for a next section that is temporally adjacent in the original musical piece and an alternative section having a same attribute as the next section, and generating a plurality of section sequences; and
selecting at least one section sequence from the plurality of section sequences.

20. A program for causing a computer controlling an information processing apparatus to function as:
a searching unit that searches each of a plurality of sections included in an original musical piece for a next section that is temporally adjacent in the original musical piece and an alternative section having a same attribute as the next section, and generates a plurality of section sequences; and
a selecting unit that selects at least one section sequence from the plurality of section sequences.
